(19) United States
(12) Patent Application Publication
(10) Pub. No.: US 2022/0308878 A1
(43) Pub. Date: Sep. 29, 2022

(54) Branch-History Mode Trace Encoder

(71) Applicant: SiFive, Inc., San Mateo, CA (US)

(72) Inventors: Bruce Ableidinger, Vancouver, WA (US); Ernest L. Edgar, Colorado Springs, CO (US)

(21) Appl. No.: 17/698,032

(22) Filed: Mar. 18, 2022

Related U.S. Application Data
(60) Provisional application No. 63/167,516, filed on Mar. 29, 2021.

(51) Int. Cl. G06F 9/30; G06F 9/32; G06F 9/38

(52) U.S. Cl. CPC G06F 9/30145; G06F 9/321; G06F 9/30054; G06F 9/3808; G06F 9/3806; G06F 9/30065

(57) ABSTRACT

A trace encoder may be connected to a processor core. The trace encoder may be configured to maintain a count of branches that are consecutively taken when executed by the processor core and/or a count of branches that are consecutively not-taken when executed by the processor core. The trace encoder may be configured to send a message including the count.

### CROSS-REFERENCE TO RELATED APPLICATION(S)

This application claims priority to and the benefit of U.S. Provisional Application Patent Ser. No. 63/167,516, filed Mar. 29, 2021, the entire disclosure of which is hereby incorporated by reference.

### TECHNICAL FIELD

This disclosure relates generally to instruction tracing, and more specifically, to instruction tracing using a branch-history mode trace encoder.

### BACKGROUND

Instruction tracing is a technique used to analyze the history of instructions executed by a processor core. The information collected may be analyzed to determine system performance and to help identify possible optimizations for improving the system.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a block diagram of an example of a system for instruction tracing using a branch-history mode trace encoder.

FIG. 2 is a block diagram of an example of a system for instruction tracing using multiple branch-history mode trace encoders.

FIG. 3 is a block diagram of an example of a branch-history mode trace encoder.

FIG. 4 is a block diagram of another example of a branch-history mode trace encoder.

FIG. 5 is block diagram of an example of a system for use with instruction tracing.

FIG. 6 is a flow chart of an example of a process for instruction tracing using a branch-history mode trace encoder.

FIG. 7 is a flow chart of another example of a process for instruction tracing using a branch-history mode trace encoder.

FIG. 8 is a flow chart of another example of a process for instruction tracing using a branch-history mode trace encoder.

### DETAILED DESCRIPTION

To permit instruction tracing, a system may implement a trace encoder connected to a Central Processing Unit (CPU) or processor core. The trace encoder may receive instruction trace information (e.g., instruction addresses, instruction types, context information, and the like) from a processor core, may compress the instruction trace information into lower bandwidth trace packets or messages, and may send the messages to a trace buffer (e.g., part of a memory system, such as static random access memory and/or dynamic random access memory) via a transmission channel. In turn, a trace decoder may access the messages to determine the instructions that were executed by the processor core. For example, instruction tracing associated with the RISC-V instruction set architecture (ISA) is described in “RISC-V Processor Trace,” version 1.0, dated Mar. 20, 2020, available at https://github.com/riscv/riscv-trace-spec/raw/e372bd36abc1b72ccbff31494a73a862367cbb29/riscv-trace-spec .pdf.

As systems grow to include more processor cores, the number of instructions being executed in a system may continue to grow. As a result, the transmission channel used by a trace encoder might not have sufficient bandwidth for supporting messages to be sent. In a mode referred to as branch trace messaging (BTM) (also referred to as BTM mode), a trace encoder may limit the messages being sent to messages indicating branches that are taken or exceptions that occur (collectively known as program flow discontinuities). A branch is an instruction that conditionally changes the execution flow associated with a processor core (e.g., causes a change in a program counter (PC) associated with the processor core that is other than a difference between two instructions placed consecutively in memory). A branch may be “taken” when executed by a processor core, which may redirect the PC to an instruction other than a next instruction in the execution flow. A branch could also not be “not-taken” when executed by the processor core, which may advance the PC to a next instruction in the execution flow. An exception is a condition occurring at run time associated with an instruction being executed by a processor core, such as a lower priority process executing to redirect the PC to a different sequence of code. With knowledge of the program being executed, a trace decoder may use the messages from the trace encoder (e.g., reference the taken branches and/or exceptions in messages) to determine the instructions that were executed by the processor core. This may permit instruction tracing while reducing the number of messages being sent. For example, BTM is described in “The Nexus 5001 Forum™ Standard for a Global Embedded Processor Debug Interface,” Version 3.0, dated 1 Jun. 2012, available at https://nexus5001.org/wp-content/uploads/2018/05/IEEE-ISTO-5001-2012-v3.0.1-Nexus-Standard.pdf.

Additionally, in a mode referred to as history trace messaging (HTM) (also referred to as HTM mode), the trace encoder may further limit those messages being sent to messages indicating indirect jumps, exceptions that occur, and/or sync events. An indirect jump is an instruction that unconditionally changes the execution flow by changing the PC to a computed value (e.g., causes a change in the PC to a target address that is calculated). The target address of an indirect jump may be “uninferable” (e.g., the target address is not supplied via a constant embedded within the jump opcode). An indirect jump may be in contrast with a direct jump, an instruction that unconditionally changes the execution flow by changing the PC to a constant value. The target address of a direct jump may be “inferable” (e.g., the target address is supplied via a constant embedded within the jump opcode). An indirect jump may also be in contrast with a direct branch (e.g., an instruction that conditionally changes the execution flow associated with a processor core by changing the PC to a constant value). The target address of a direct branch may be inferable from the program being executed. Further, in the RISC-V architecture, an indirect jump may be in contrast with conditional branches as conditional branches are inferable. With HTM, the results of branches (e.g., taken or not-taken) may be stored in a history buffer, such as a shift register (e.g., a branch that is taken may be represented by a “1” in the shift register, while a branch that is not-taken may be represented by a “0” in the shift register, which may result in a bitmap). When an indirect jump occurs, the trace encoder may send an indirect branch history message (IBHM) indicating the target address of the jump (e.g., the computed value), along with the contents of the history buffer (e.g., the contents of the shift register). In other words, an indirect jump may cause an IBHM. The IBHM may also indicate an instruction count indicating the number of instructions that were executed since the previous IBHM was sent (e.g., including unconditional jumps and conditional branches represented by the history buffer). A sync event may comprise sending a sync message (SYNC) including a complete target address of a jump (as opposed to an IBHM indicating a compressed target address of a jump, which may be a delta from a previous address that was sent, such as a product of an “exclusive or” (XOR) function).

The history buffer may comprise finite hardware that is implemented by the trace encoder. For example, the history buffer may comprise a 32-bit shift register that is implemented by the trace encoder. In some cases, it is possible for the history buffer to fill before an IBHM is sent. When this occurs, a resource full message (RFM) indicating the contents of the history buffer may be sent. For example, when the 32-bit shift register fills (e.g., stores 32-bits corresponding to whether 32 branches were being taken or not-taken), an RFM may be sent indicating the 32-bits (e.g., a bit map corresponding to the branches). In some cases, many RFMs may be sent before an IBHM is sent, and in some cases, the RFMs may indicate the same result for each branch indicated in the RFM (e.g., all branches consecutively taken, or all branches consecutively not-taken). For example, when a processor core executes a loop, such as to poll a register or memory location for a given value, the processor core may execute a same branch in memory multiple times with the branch having the same result each time (e.g., taken or not-taken). This may cause numerous RFMs to be sent before an IBHM is sent, with each RFM indicating the same result repeated for each execution of the branch (e.g., repeatedly taken or repeatedly not-taken).

To reduce the consumption of bandwidth associated with the transmission channel used by the trace encoder, a branch-history mode (BHM) trace encoder (or simply “trace encoder”) may implement a repeat branch optimization. The trace encoder may be connected to a processor core via a trace interface. The trace encoder may receive instruction trace information (e.g., instruction addresses, instruction types, context information, and the like) from the processor core via the trace interface. The trace encoder may execute in a BTM mode or HTM mode. In the HTM mode, the trace encoder may store the results of branches (e.g., taken or not-taken) in a history buffer (e.g., a shift register). When the history buffer fills with branches having a same result (e.g., all branches consecutively taken, or all branches consecutively not-taken), the trace encoder may start a count of the branches (e.g., “branch count”) associated with the same result without sending an RFM. The trace encoder may clear the history buffer of the individual branch results, store the branch count in the history buffer, and continue to update (e.g., maintain) the branch count stored in the history buffer when a next branch generates the same result (e.g., increment the count). The trace encoder may continue in this way, updating the count when a next branch generates the same result, until a next branch is executed by the processor core with an opposite result (e.g., until a branch is not-taken after multiple branches have been taken, or until a branch is taken after multiple branches have not been taken). When this occurs the trace encoder may send an RFM indicating the branch count (e.g., stored as a count in the history buffer). As a result, the number of messages sent by the trace encoder may be reduced by sending one message including a count of redundant results, as opposed to multiple messages including the redundant results. This may improve the bandwidth associated with the transmission channel.

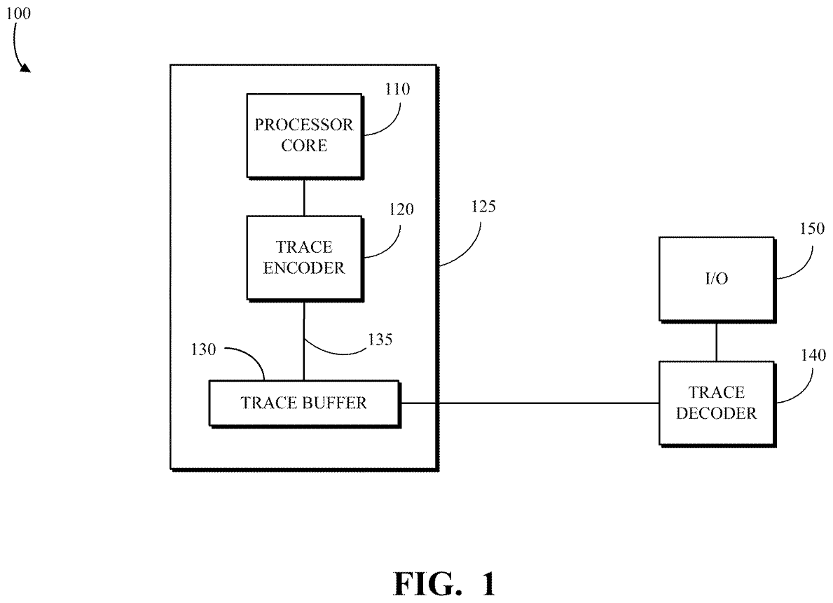

FIG. 1 is a block diagram of an example of a system 100 for instruction tracing using a branch-history mode (BHM) trace encoder. The system may include a processor core 110, a trace encoder 120, a trace buffer 130, a trace decoder 140, and/or an input/output (I/O) device 150. In some implementations, the processor core 110, the trace encoder 120, and the trace buffer 130 may be implemented together in an integrated circuit 125, such as an application-specific integrated circuit (ASIC) or a system on a chip (SoC). In some implementations, one or more of the processor core 110, the trace encoder 120, and the trace buffer 130 may be implemented separately. The processor core 110 may be a CPU comprising one or more of data paths, execution units, caches, registers, and the like, implementing a microarchitecture for executing instructions according to an instruction set architecture (ISA). For example, the processor core 110 may be a CPU implementing a microarchitecture for executing RISC-V instructions.

To permit instruction tracing, the trace encoder 120 is connected to the processor core 110. As the processor core 110 executes instructions, the processor core 110 generates instruction trace information that is sent to the trace encoder 120 (e.g., instruction addresses, instruction types, context information, and the like). The trace encoder 120 may receive the instruction trace information and may compress the information into lower bandwidth trace packets or messages for instruction tracing. The trace encoder 120 may send the messages to the trace buffer 130, or memory, via a transmission channel 135. For example, the trace buffer 130 may be part of a memory system, such as static random access memory and/or dynamic random access memory. The trace decoder 140 may access the messages in the trace buffer 130 to determine the instructions that were executed by the processor core 110. For example, the trace decoder 140 may execute trace de-queueing software to organize the instructions in an order in which they were executed by the processor core 110 to reconstruct an execution flow. In some implementations, the trace decoder 140 may organize the instructions and reconstruct the execution flow with knowledge of the program that was executed by the processor core 110 (e.g., accessing the source code). The trace decoder 140 may output the execution flow to a graphical user interface (GUI) associated with the I/O device 150 (e.g., a computer) so that the execution flow may be viewed by a user (e.g., the GUI may permit a user to scroll back and forth to see instructions that were executed by the processor core 110). For example, the trace decoder 140 and/or the I/O device 150 may execute post-acquisition display software to display instructions associated with the program that was executed (e.g., the source code) and to display instructions that were actually executed by the processor core 110, in the order they were executed.

The trace encoder 120 may be BHM trace encoder comprising hardware, software, and/or a combination thereof. The trace encoder 120 may be configured to selectively operate in a BTM mode or an HTM mode. The trace encoder 120 may include a history buffer for storing the results of branches (e.g., taken or not-taken) when operating in the HTM mode. To reduce the consumption of bandwidth associated with the transmission channel 135, the trace encoder 120 may implement a repeat branch optimization. With the repeat branch optimization, the trace encoder 120 may maintain a count of branches that are consecutively taken, and/or a count of branches that are consecutively not-taken, when executed by the processor core 110. The trace encoder 120 may send a message including the count, such as a message including the count to the trace buffer 130 via the transmission channel 135. As a result, the number of messages sent by the trace encoder 120 may be reduced by sending one message including a count of redundant results, as opposed to multiple messages including the redundant results. This may improve the bandwidth associated with the transmission channel 135.

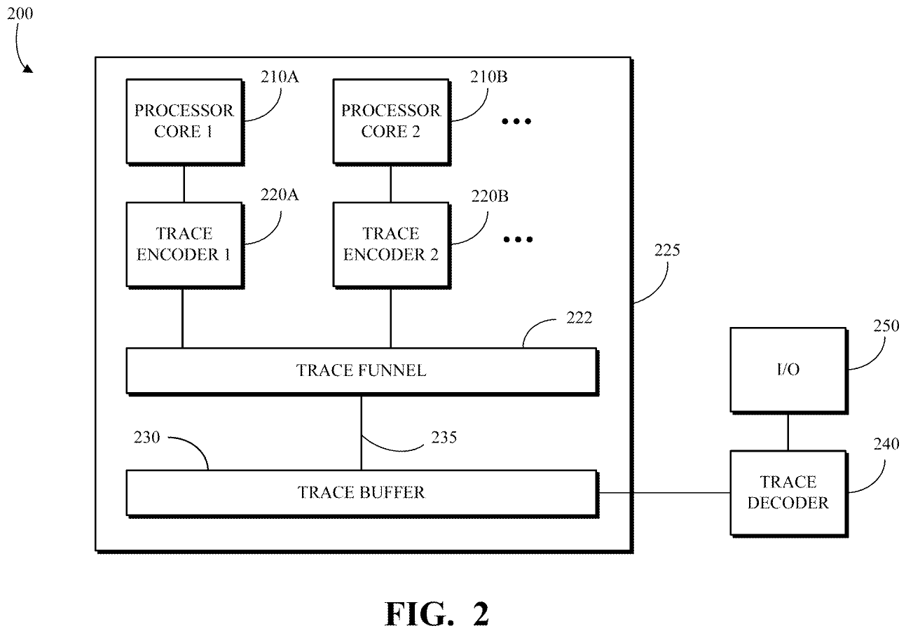

FIG. 2 is a block diagram of an example of a system 200 for instruction tracing using multiple trace encoders. The system 200 may include processor cores, such as processor cores 210A and 210B; trace encoders, such as trace encoders 220A and 220B; a trace funnel 222; a trace buffer 230; a trace decoder 240; and/or an I/O device 250. The processor cores 210A and 210B may be like the processor core 110 shown in FIG. 1. The trace encoders 220A and 220B may be like the trace encoder 120 shown in FIG. 1. The trace buffer 230, the trace decoder 240, and the I/O device 250 may be like the trace buffer 130, the trace decoder 140, and the I/O device 150 shown in FIG. 1, respectively. In some implementations, the processor cores 210A and 210B, the trace encoders 220A and 220B, the trace funnel 222, and the trace buffer 230 may be implemented together in an integrated circuit 225 like the integrated circuit 125 shown in FIG. 1. In some implementations, one or more of the processor cores 210A and 210B, the trace encoders 220A and 220B, the trace funnel 222, and the trace buffer 230 may be implemented separately. To permit instruction tracing of the processor cores (e.g., the processor cores 110A and 110B), the trace encoders (e.g., the trace encoders 220A and 220B) may be individually connected to the processor cores (e.g., one trace encoder per processor core). For example, the trace encoder 220A may be connected to the processor core 210A, the trace encoder 220B may be connected to the processor core 210B, and so forth. As the processor cores (e.g., the processor cores 110A and 110B) execute instructions, the processor cores generate instruction trace information that is sent to the trace encoders (e.g., the trace encoders 220A and 220B) to which they are connected. The trace encoders may receive the instruction trace information and may compress the information into lower bandwidth messages for instruction tracing. The trace encoders may send the messages to the trace funnel 222. The messages sent by the trace encoders may include trace identifiers that indicate the processor cores that are associated with the message. For example, the trace encoder 220A may send a message to the trace funnel 222 with a trace identifier that indicates the message is associated with the processor core 210A; the trace encoder 220B may send a message to the trace funnel 222 with a trace identifier that indicates the message is associated with the processor core 210B; and so forth. The trace funnel 222 may produce system trace messages that are sent to the trace buffer 230 via a transmission channel 235. For example, the trace buffer 230 may be part of a memory system, such as static random access memory and/or dynamic random access memory. The system trace messages may include the trace identifiers that indicate the processor cores that are associated with the individual messages. This may permit the trace decoder 240, when accessing the trace buffer 230, to determine which instructions were executed by which processor core (e.g., of the processor cores 210A and 210B). In some implementations, the trace funnel 222 may interleave the trace messages from the trace encoders when sending the system trace messages. In some implementations, the trace decoder 240 may de-interleave the system trace messages, based on the trace identifiers, to establish one stream for each processor core. The trace identifiers may further permit associating instructions with processor cores for display via the I/O device 250.

To reduce the consumption of bandwidth associated with the transmission channel 235, such as when there are many processor cores and trace encoders implemented in the integrated circuit 225, the trace encoders (e.g., the trace encoders 220A and 220B) may implement a repeat branch optimization. With the repeat branch optimization, the trace encoders may maintain a count of branches that are consecutively taken, and/or a count of branches that are consecutively not-taken, when executed by the processor cores. The trace encoders may send messages including the count, such as messages including the count to the trace funnel 222, which may be forwarded by the trace funnel 222 to the trace buffer 230 via the transmission channel 235. As a result, the number of messages sent via the transmission channel 235 may be reduced by sending messages including a count of redundant results, as opposed to multiple messages including the redundant results. This may improve the bandwidth associated with the transmission channel 235.

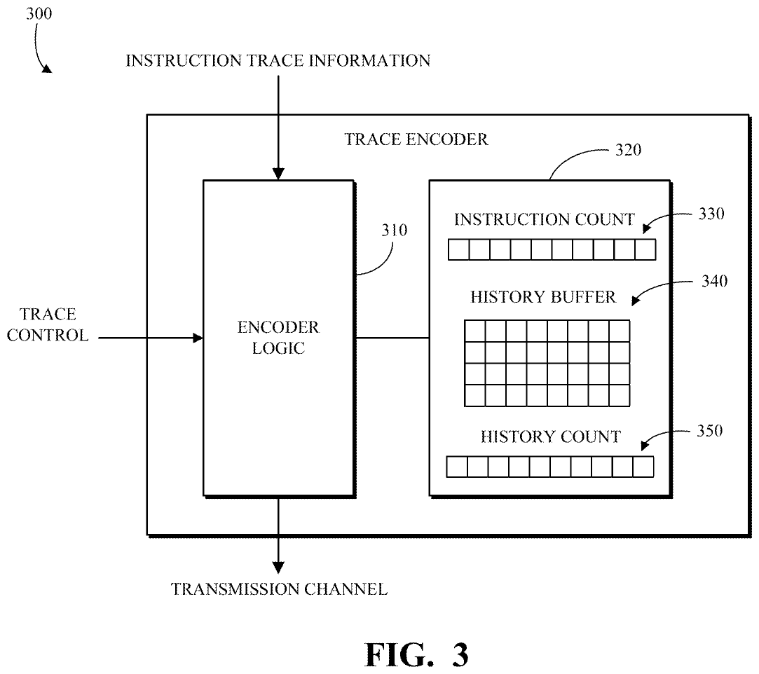

FIG. 3 is a block diagram of an example of a trace encoder 300. The trace encoder 300 may be like the trace encoder 120 shown in FIG. 1 and/or like the trace encoder 220A or the trace encoder 220B shown in FIG. 2. The trace encoder 300 may include an encoder logic 310 and a storage 320. The encoder logic 310 may receive instruction trace information from a processor core like the processor core 110 shown in FIG. 1 and/or like the processor core 210A or the processor core 210B shown in FIG. 2. The encoder logic 310 may be configured using a trace control input. For example, configuring the encoder logic 310 via the trace control may include selecting to operate in the BTM mode or the HTM mode, and selecting to enable or disable the repeat branch optimization, among other things. As configured, the encoder logic 310 may receive instruction trace information from the processor core and may compress the information into lower bandwidth messages for instruction tracing. The encoder logic 310 may send the messages to a trace buffer via a transmission channel, like the trace buffer 130 and the transmission channel 135 shown in FIG. 1, and/or like the trace buffer 230 and the transmission channel 235 shown in FIG. 2.

The storage 320 may include an instruction count buffer 330 for storing an instruction count (e.g., I-CNT) indicating the number of instructions that were executed since a previous IBHM was sent (e.g., including unconditional jumps and conditional branches represented by a history buffer 340 as discussed below) when operating in the HTM mode. The instruction count buffer 330 may comprise a counter, such as a 10-bit counter for counting up to 1024 instructions. When an indirect jump occurs, the trace encoder 300 may send an IBHM indicating the target address of the jump (e.g., the computed value), along with the contents of the instruction count buffer 330 (e.g., the instruction count) and/or the history buffer 340.

In some cases, it is possible for the instruction count buffer 330 to reach a maximum count before an IBHM is sent (e.g., each bit of the 10-bit counter including a “1,” indicating a count of 1024 instructions). When this occurs, the trace encoder 300 may send an RFM indicating the instruction count (e.g., the maximum count, as stored in the instruction count buffer 330). After the RFM is sent, the encoder logic 310 may clear the instruction count buffer 330 and start again to count the number of instructions being executed.

The storage 320 may also include a history buffer 340 for storing the results of branches (e.g., a bitmap of branch results indicating taken or not-taken for each branch) (e.g., HIST) that were executed since a previous IBHM was sent when operating in the HTM mode. For example, the history buffer 340 may store the results of branches associated with target addresses that are inferable from the program being executed by the processor core. The history buffer 340 may comprise a shift register, such as a 32-bit shift register for storing the results (e.g., taken or not-taken) of 32 branches (e.g., a branch that is taken by the processor core may cause a bit that indicates the branch was taken to be stored in the history buffer 340, such as a “1” being shifted into the shift register, while a branch that is not-taken by the processor core may cause a bit that indicates the branch was not-taken to be stored in the history buffer 340, such as a “0” being shifted into the shift register). When an indirect jump occurs, the trace encoder 300 may send an IBHM indicating the target address of the jump (e.g., the computed value), along with the contents of the instruction count buffer 330 as discussed above and/or the history buffer 340 (e.g., the results of the branches, taken or not-taken).

In some cases, it is possible for the history buffer 340 to fill before an IBHM is sent (e.g., each bit of the 32-bit shift register including a “1” indicating a branch that was taken or a “0” indicating a branch that was not-taken). When this occurs, the trace encoder 300 may send an RFM indicating the branch history results (e.g., stored as individual results in the history buffer 340). After the RFM is sent, or after an IBHM is sent, the encoder logic 310 may clear the history buffer 340 and start again to store the results of branches being executed.

To reduce the consumption of bandwidth associated with the transmission channel, the trace encoder 300 may implement a repeat branch optimization. With the repeat branch optimization, the trace encoder 300 may maintain a count of branches that are consecutively taken, and/or a count of branches that are consecutively not-taken, when executed by the processor core. For example, when the history buffer 340 fills with branches having a same result (e.g., all branches consecutively taken, or all branches consecutively not-taken), the trace encoder 300 may start a count of the branches (e.g., branch count) associated with the same result without sending an RFM. In some implementations, the trace encoder 300 may store the count of the branches in a history count buffer 350 (e.g., H-CNT). The history count buffer 350 may comprise a counter, such as a 10-bit counter for counting up to 1024 instructions. The trace encoder 300 may update (e.g., maintain) the branch count stored in the history count buffer 350 when a next branch generates the same result (e.g., increment the count). The trace encoder 300 may continue in this way, updating the count when a next branch generates the same result, until a next branch is executed by the processor core with an opposite result (e.g., until a branch is not-taken after multiple branches have been taken, or until a branch is taken after multiple branches have not been taken). In some implementations, the trace encoder 300 may maintain the count while tracking results of individual branches in the history buffer 340. When this opposite result occurs (e.g., responsive to a branch executing with the opposite result), the trace encoder 300 may send an RFM indicating the branch count (e.g., stored as a count in the history count buffer 350). The RFM may also include an indication of whether the count is of branches that were consecutively taken (e.g., “1”) or of branches that were consecutively not-taken (e.g., “0”). As a result, the number of messages sent by the trace encoder 300 may be reduced by sending one message including a count of redundant results, as opposed to multiple messages including the redundant results. This may improve the bandwidth associated with the transmission channel.

After the RFM including the branch count is sent, the encoder logic 310 may continue to store the results of branches being executed in the history buffer 340 (e.g., a branch that is taken being represented by a “1” shifted into the shift register, and a branch that is not-taken being represented by a “0” shifted into the shift register), including storing the result of the branch having the opposite result (e.g., the branch causing the RFM). Then, when an indirect jump occurs, the trace encoder 300 may send an IBHM indicating the target address of the jump (e.g., the computed value), along with the contents of the instruction count buffer 330 as discussed above and/or the history buffer 340 (e.g., the results of the branches, taken or not-taken, including the result of the branch having the opposite result).

In some cases, it is possible for the history count buffer 350 to reach a maximum count before executing a branch having the opposite result (e.g., each bit of the 10-bit counter including a “1,” indicating a count of 1024 branches that are taken, or a count of 1024 branches that are not-taken). When this occurs, the trace encoder 300 may send an RFM indicating the branch count (e.g., the maximum count, as stored in the history count buffer 350). After the RFM is sent, the encoder logic 310 may clear the history count buffer 350 and start again to count consecutive branches having the same result.

In some cases, the count of branches (e.g., branch count) may be is associated with a same branch instruction in memory that executes in a loop. For example, when a processor core executes a loop, such as to poll a register or memory location for a given value, the processor core may execute a same branch in memory multiple times with the branch having the same result each time (e.g., taken or not-taken). This may cause numerous RFMs to be sent before an IBHM is sent, with each RFM indicating the same result repeated for each execution of the branch (e.g., repeatedly taken or repeatedly not-taken). The repeat branch optimization may permit sending one message including a count of the repeated results, as opposed to multiple messages repeating the results. For example, when executing the “while” loop below (e.g., while (*uart_status & 1) { }), which may execute to poll a register or memory location, the loop may read “1” (e.g., the resource is busy) consecutively 10,000 times before reading “0” (e.g., the resource is available). This may cause a same branch instruction in memory (e.g., “bnez” at address 1008) to execute 10,000 times with a same consecutive result before executing with an opposite result.

| Addr | Instruction | BTM | HTM |
|---|---|---|---|
| 1000 | lw x6, 0(x2) | | |
| 1004 | andi x6, x6, 1 | | |
| 1008 | bnez x6, 1000 | Direct, ICNT = 6 | HIST = (HIST << 1) \| 1 |

As shown above, the “while” loop may load a word from an address (e.g., “lw” instruction at address 1000), check the value that was loaded (e.g., “andi” instruction at address 1004), and jump back to load the word again from the address until the condition is satisfied (e.g., “bnez” instruction at address 1008). In the BTM mode, the “while” loop above may generate 10,000 direct branch messages, which could occupy 20,000 bytes of space in the trace, buffer before the condition is satisfied (e.g., each branch message in the Nexus format may be 2 bytes). In the HTM mode, with the history buffer 340 comprising a 32-bit shift register, the “while” loop above may generate 312 RFMs, with each RFM indicating 32 branches taken (e.g., redundant results). This could occupy 2184 bytes of space in the trace buffer before the condition is satisfied. With the repeat branch optimization, the history count buffer 350 may store the count of 10,000, as opposed to the 10,000 individual branch results. This may permit one RFM to be sent that indicates the count of 10,000 and indicates the count is of branches that are taken. This could use 4 bytes of space in the trace buffer before the condition is satisfied. A final branch that is not-taken (e.g., causing an exit of the “while” loop) may then be loaded into the history buffer 340 as individual result to be reported the next time the history buffer 340 is sent (e.g., an IBHM or RFM).

In another example, when executing the “for” loop below (e.g., for (i=0; i<10000; i++) {buf[i]=0}), which may execute to initialize a block of memory to zero, the loop may compile into an instruction sequence with a conditional branch at the top and an unconditional jump at the bottom. The conditional branch may be repeatedly not-taken (e.g., 10,000 times) until the loop exits.

| Addr | Instruction | BTM | HTM |
|---|---|---|---|
| 1000 | lui x6, 0 | | |
| 1004 | lui x7, 10000 | | |
| 1008 | bge x6, x7, 101c | | HIST = (HIST << 1) \| |
| | | | 0 |
| 100c | add x28, x3, x6 | | |
| 1010 | sw buf(x28), x0 | | |
| 1014 | addi x6, x6, 1 | | |
| 1018 | jal x0, 1008 | Direct, ICNT = 10 | Inferable jump = |
| | | | no message |

As shown above, the “for” loop may include a header specifying the iteration (e.g., “lui” instructions at addresses 1000 and 1004) and a body that is executed once per iteration (e.g., “bge,” “add,” “sw” “addi,” and “jal” instructions at addresses 1008, 100c, 1010, 1014, and 1018). In the BTM mode, the “for” loop above may generate 10,000 direct branch messages, which could occupy 20,000 bytes of space in the trace buffer, before the condition is satisfied (e.g., each branch message in the Nexus format may be 2 bytes). In the HTM mode, with the history buffer 340 comprising a 32-bit shift register, the “for” loop above may generate 312 RFMs, with each RFM indicating 32 branches not-taken (e.g., redundant results). This could occupy 2184 bytes of space in the trace buffer before the condition is satisfied. With the repeat branch optimization, the history count buffer 350 may store the count of 10,000, as opposed to the 10,000 individual branch results. This may permit one RFM to be sent that indicates the count of 10,000 and indicates the count is of branches that are not-taken. This could use 4 bytes of space in the trace buffer before the condition is satisfied. A final branch that is taken (e.g., causing an exit of the “for” loop) may then be loaded into the history buffer 340 as individual result to be reported the next time the history buffer 340 is sent (e.g., an IBHM or RFM).

In other words, a long sequence of taken branches, or a long sequence of not-taken branches, may be common in embedded software, such as when polling hardware registers or memory locations or when initializing blocks of memory. In the HTM mode, this may cause multiple RFMs to be sent, with each RFM indicating all “1's” (e.g., all branches taken) or all “0's” (e.g., all branches not-taken). With the repeat branch optimization, one RFM may be sent with a branch count (e.g., a count of the branches taken, or a count of the branches not-taken) and indication of whether the count is of branches taken or not-taken. This may reduce the number of messages being sent, which may improve bandwidth in the system.

Below is an example of a format of an RFM that may be sent by the trace encoder 300. A timestamp field (“TSTAMP”) may indicate a number of cycles that have passed since a previous message was sent. A resource data field (“RDATA”) may indicate an instruction count (e.g., when RCODE=0), a branch history, such as a bitmap of branch results (e.g., when a resource code (“RCODE”)=1), a count of taken branches (e.g., when RCODE=8), or a count of not-taken branches (e.g., when RCODE=9). A trace identifier or source field (“SRC”) may indicate the processor core that is associated with the message. A transaction code field (“TCODE”) may indicate the type of message being sent for use by a trace decoder like the trace decoder 140 shown in FIG. 1 and/or the trace decoder 240 shown in FIG. 2. The RFM may have a variable length based on the resource data field and/or the timestamp field./

Resource Full Message

| Bits | Name | Description |
|---|---|---|
| var | TSTAMP | Timestamp value |
| var | RDATA | I-CNT (RCODE = 0), HIST (RCODE = 1), or count |
| | | (RCODE = 8 or 9) |
| 4 | RCODE | Resource code (0 = I-CNT, 1 = HIST, 8 = |
| | | HIST_NOTTAKEN, 9 = HIST_TAKEN) |
| n | SRC | Source of this message (width is teImpl.nSrcBits) |
| 6 | TCODE | Value = 27 |

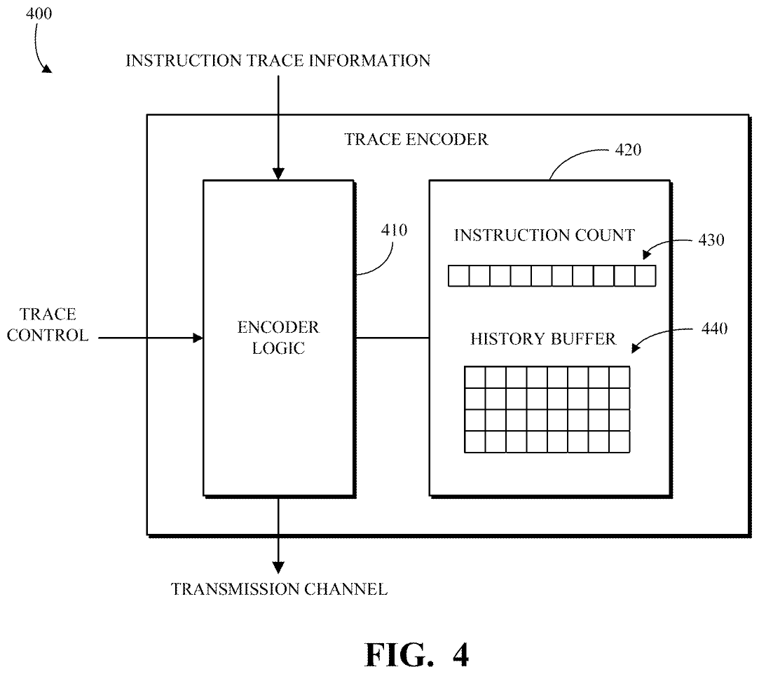

FIG. 4 is a block diagram of an example of a trace encoder 400. The trace encoder 400 may be like the trace encoder 120 shown in FIG. 1 and/or like the trace encoder 220A or the trace encoder 220B shown in FIG. 2. The trace encoder 400 may include an encoder logic 410 and a storage 420. The encoder logic 410 may receive instruction trace information from a processor core like the processor core 110 shown in FIG. 1 and/or like the processor core 210A or the processor core 210B shown in FIG. 2. The encoder logic 410 may be configured using a trace control input. For example, configuring the encoder logic 410 via the trace control may include selecting to operate in the BTM mode or the HTM mode, and selecting to enable or disable the repeat branch optimization, among other things. As configured, the encoder logic 410 may receive instruction trace information from the processor core and may compress the information into lower bandwidth messages for instruction tracing. The encoder logic 410 may send the messages to a trace buffer via a transmission channel, like the trace buffer 130 and the transmission channel 135 shown in FIG. 1, and/or like the trace buffer 230 and the transmission channel 235 shown in FIG. 2.

The storage 420 may include an instruction count buffer 430 for storing an instruction count (e.g., I-CNT) indicating the number of instructions that were executed since a previous IBHM was sent (e.g., including unconditional jumps and conditional branches represented by a history buffer 440 as discussed below) when operating in the HTM mode. The instruction count buffer 430 may comprise a counter, such as a 10-bit counter for counting up to 1024 instructions. When an indirect jump occurs, the trace encoder 400 may send an IBHM indicating the target address of the jump (e.g., the computed value), along with the contents of the instruction count buffer 430 (e.g., the instruction count) and/or the history buffer 440.

In some cases, it is possible for the instruction count buffer 430 to reach a maximum count before an IBHM is sent (e.g., each bit of the 10-bit counter is including a “1,” indicating a count of 1024 instructions). When this occurs, the trace encoder 400 may send an RFM indicating the instruction count (e.g., the maximum count, as stored in the instruction count buffer 430). After the RFM is sent, the encoder logic 410 may clear the instruction count buffer 430 and start again to count the number of instructions being executed.

The storage 420 may also include a history buffer 440 for storing the results of branches (e.g., a bitmap of branch results indicating taken or not-taken for each branch) (e.g., HIST) that were executed since a previous IBHM was sent when operating in the HTM mode. For example, the history buffer 440 may store the results of branches associated with target addresses that are inferable from the program being executed by the processor core. The history buffer 440 may comprise a shift register, such as a 32-bit shift register for storing the results (e.g., taken or not-taken) of 32 branches (e.g., a branch that is taken by the processor core may cause a bit that indicates the branch was taken to be stored in the history buffer 440, such as a “1” being shifted into the shift register, while a branch that is not-taken by the processor core may cause a bit that indicates the branch was not-taken to be stored in the history buffer 440, such as a “0” being shifted into the shift register). When an indirect jump occurs, the trace encoder 400 may send an IBHM indicating the target address of the jump (e.g., the computed value), along with the contents of the instruction count buffer 430 as discussed above and/or the history buffer 440 (e.g., the results of the branches, taken or not-taken).

In some cases, it is possible for the history buffer 440 to fill before an IBHM is sent (e.g., each bit of the 32-bit shift register including a “1” indicating a branch that was taken or a “0” indicating a branch that was not-taken). When this occurs, the trace encoder 400 may send an RFM indicating the branch history results (e.g., stored as individual results in the history buffer 440). After the RFM is sent, or after an IBHM is sent, the encoder logic 410 may clear the history buffer 440 and start again to store the results of branches being executed.

To reduce the consumption of bandwidth associated with the transmission channel, the trace encoder 400 may implement a repeat branch optimization. With the repeat branch optimization, the trace encoder 400 may maintain a count of branches that are consecutively taken, and/or a count of branches that are consecutively not-taken, when executed by the processor core. For example, when the history buffer 440 fills with branches having a same result (e.g., all branches consecutively taken, or all branches consecutively not-taken), the trace encoder 400 may start a count of the branches (e.g., branch count) associated with the same result without sending an RFM. In some implementations, the trace encoder 400 may clear the history buffer 440 of the individual branch results, store the branch count in the history buffer 440, and continue to update (e.g., maintain) the branch count stored in the history buffer 440 when a next branch generates the same result (e.g., increment the count). The trace encoder 400 may continue in this way, updating the count when a next branch generates the same result, until a next branch is executed by the processor core with an opposite result (e.g., until a branch is not-taken after multiple branches have been taken, or until a branch is taken after multiple branches have not been taken). When this opposite result occurs (e.g., responsive to a branch executing with the opposite result), the trace encoder 400 may send an RFM indicating the branch count (e.g., stored as a count in the history buffer 440). The RFM may also include an indication of whether the count is of branches that were consecutively taken (e.g., “1”) or of branches that were consecutively not-taken (e.g., “0”). As a result, the number of messages sent by the trace encoder 400 may be reduced by sending one message including a count of redundant results, as opposed to multiple messages including the redundant results. This may improve the bandwidth associated with the transmission channel.

In some implementations, after the RFM including the branch count is sent, the encoder logic 410 may clear the history buffer 440 and may continue to store the results of branches being executed in the history buffer 440 (e.g., a branch that is taken being represented by a “1” shifted into the shift register, and a branch that is not-taken being represented by a “0” shifted into the shift register), including storing the result of the branch having the opposite result (e.g., the branch causing the RFM). Then, when an indirect jump occurs, the trace encoder 400 may send an IBHM indicating the target address of the jump (e.g., the computed value), along with the contents of the instruction count buffer 430 as discussed above and/or the history buffer 440 (e.g., the results of the branches, taken or not-taken, including the result of the branch having the opposite result).

In some cases, it is possible for the history buffer 440 to reach a maximum count before executing a branch having the opposite result (e.g., each bit of the 32-bit shift register including a “1,” indicating a count of 2 to the power of 32 branches that are consecutively taken or consecutively not-taken). When this occurs, the trace encoder 400 may send an RFM indicating the branch count (e.g., the maximum count, as stored in the history buffer 440). In some implementations, after the RFM is sent, the encoder logic 410 may clear the history buffer 440 and start again to count consecutive branches having the same result.

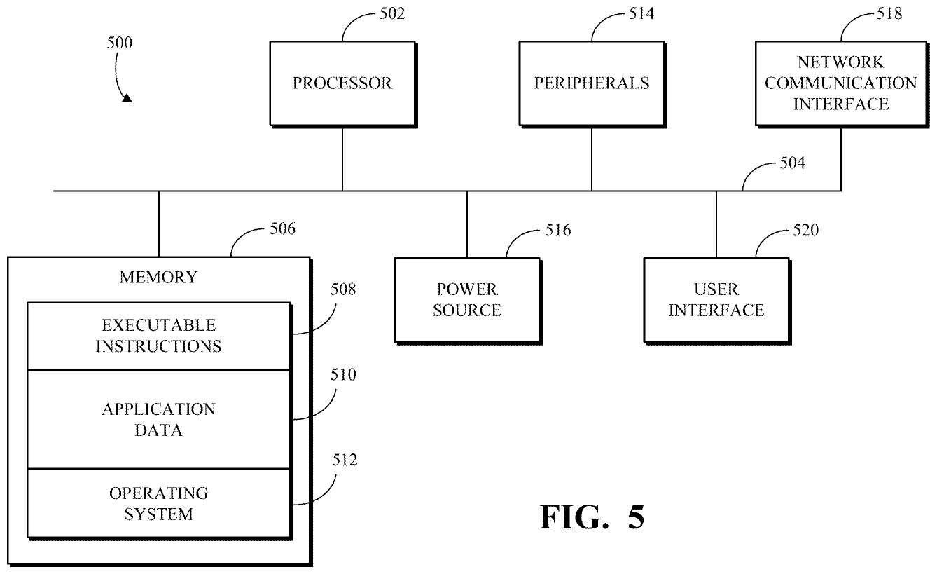

FIG. 5 is block diagram of an example of a system 500 for use with instruction tracing. The system 500 is an example of an internal configuration of a computing device that may be used to implement one or more parts of the system 100 shown in FIG. 1 and/or the system 200 shown in FIG. 2, such as the trace encoder 120, the trace buffer 130, the trace decoder 140, and the I/O device 150 shown FIG. 1, or the trace encoder 120A, the trace encoder 120B, the trace buffer 230, the trace decoder 240, and the I/O device 250 shown FIG. 2. The system 500 can include components or units, such as a processor 502, a bus 504, a memory 506, peripherals 514, a power source 516, a network communication interface 518, a user interface 520, other suitable components, or a combination thereof.

The processor 502 can be a central processing unit (CPU), such as a microprocessor, and can include single or multiple processors having single or multiple processing cores. Alternatively, the processor 502 can include another type of device, or multiple devices, now existing or hereafter developed, capable of manipulating or processing information. For example, the processor 502 can include multiple processors interconnected in any manner, including hardwired or networked, including wirelessly networked. In some implementations, the operations of the processor 502 can be distributed across multiple physical devices or units that can be coupled directly or across a local area or other suitable type of network. In some implementations, the processor 502 can include a cache, or cache memory, for local storage of operating data or instructions.

The memory 506 can include volatile memory, non-volatile memory, or a combination thereof. For example, the memory 506 can include volatile memory, such as one or more DRAM modules such as double data rate (DDR) synchronous dynamic random access memory (SDRAM), and non-volatile memory, such as a disk drive, a solid state drive, flash memory, Phase-Change Memory (PCM), or any form of non-volatile memory capable of persistent electronic information storage, such as in the absence of an active power supply. The memory 506 can include another type of device, or multiple devices, now existing or hereafter developed, capable of storing data or instructions for processing by the processor 502. The processor 502 can access or manipulate data in the memory 506 via the bus 504. Although shown as a single block in FIG. 5, the memory 506 can be implemented as multiple units. For example, a system 500 can include volatile memory, such as RAM, and persistent memory, such as a hard drive or other storage.

The memory 506 can include executable instructions 508, data, such as application data 510, an operating system 512, or a combination thereof, for immediate access by the processor 502. The executable instructions 508 can include, for example, one or more application programs, which can be loaded or copied, in whole or in part, from non-volatile memory to volatile memory to be executed by the processor 502. The executable instructions 508 can be organized into programmable modules or algorithms, functional programs, codes, code segments, or combinations thereof to perform various functions described herein. For example, the executable instructions 508 can include instructions executable by the processor 502 to cause the system 500 to execute trace de-queueing software and/or post-acquisition display software associated with the trace decoder 140 and/or the I/O device 150 shown FIG. 1, or the trace decoder 240 and/or the I/O device 250 shown FIG. 2, respectively. The application data 510 can include, for example, user files, database catalogs or dictionaries, configuration information or functional programs, such as a web browser, a web server, a database server, or a combination thereof. The operating system 512 can be, for example, Microsoft Windows®, macOS®, or Linux®; an operating system for a small device, such as a smartphone or tablet device; or an operating system for a large device, such as a mainframe computer. The memory 506 can comprise one or more devices and can utilize one or more types of storage, such as solid state or magnetic storage.

The peripherals 514 can be coupled to the processor 502 via the bus 504. The peripherals 514 can be sensors or detectors, or devices containing any number of sensors or detectors, which can monitor the system 500 itself or the environment around the system 500. For example, a system 500 can contain a temperature sensor for measuring temperatures of components of the system 500, such as the processor 502. Other sensors or detectors can be used with the system 500, as can be contemplated. In some implementations, the power source 516 can be a battery, and the system 500 can operate independently of an external power distribution system. Any of the components of the system 500, such as the peripherals 514 or the power source 516, can communicate with the processor 502 via the bus 504.

The network communication interface 518 can also be coupled to the processor 502 via the bus 504. In some implementations, the network communication interface 518 can comprise one or more transceivers. The network communication interface 518 can, for example, provide a connection or link to a network, via a network interface, which can be a wired network interface, such as Ethernet, or a wireless network interface. For example, the system 500 can communicate with other devices via the network communication interface 518 and the network interface using one or more network protocols, such as Ethernet, transmission control protocol (TCP), Internet protocol (IP), power line communication (PLC), wireless fidelity (Wi-Fi), infrared, general packet radio service (GPRS), global system for mobile communications (GSM), code division multiple access (CDMA), or other suitable protocols.

A user interface 520 can include a display; a positional input device, such as a mouse, touchpad, touchscreen, or the like; a keyboard; or other suitable human or machine interface devices. The user interface 520 can be coupled to the processor 502 via the bus 504. Other interface devices that permit a user to program or otherwise use the system 500 can be provided in addition to or as an alternative to a display. In some implementations, the user interface 520 can include a display, which can be a liquid crystal display (LCD), a cathode-ray tube (CRT), a light emitting diode (LED) display (e.g., an organic light emitting diode (OLED) display), or other suitable display. In some implementations, a client or server can omit the peripherals 514. The operations of the processor 502 can be distributed across multiple clients or servers, which can be coupled directly or across a local area or other suitable type of network. The memory 506 can be distributed across multiple clients or servers, such as network-based memory or memory in multiple clients or servers performing the operations of clients or servers. Although depicted here as a single bus, the bus 504 can be composed of multiple buses, which can be connected to one another through various bridges, controllers, or adapters.

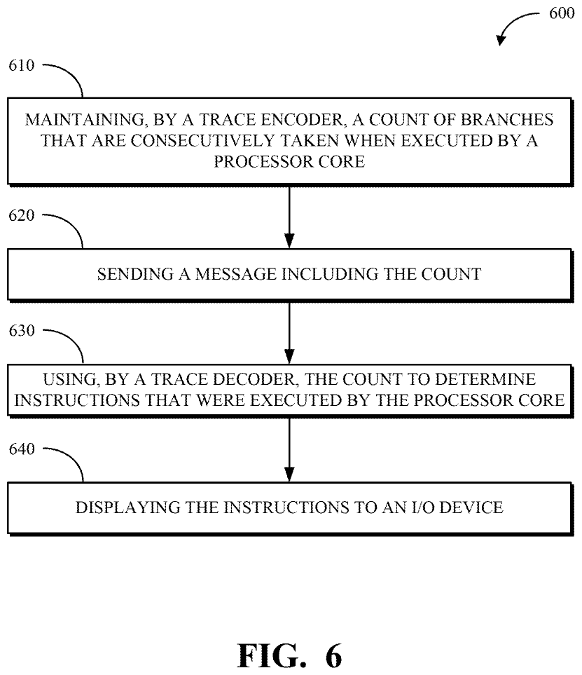

FIG. 6 is a flow chart of an example of a process 600 for instruction tracing using a BHM trace encoder. The process 600 includes maintaining 610, by a trace encoder, a count of branches that are consecutively taken when executed by a processor core; sending 620 a message including the count; using 630, by a trace decoder, the count to determine instructions that were executed by the processor core; and displaying 640 the instructions to an I/O device. For example, the process 600 may be implemented using the system 100 shown in FIG. 1, the system 200 shown in FIG. 2, the trace encoder 300 shown in FIG. 3, the trace encoder 400 shown in FIG. 4, and/or the system 500 shown in FIG. 5.

The process 600 includes maintaining 610, by a trace encoder, a count of branches that are consecutively taken when executed by a processor core. The count may be maintained by a trace encoder that implements a repeat branch optimization like the trace encoder 300 shown in FIG. 3 or the trace encoder 400 shown in FIG. 4. The count may be maintained to reduce the consumption of bandwidth associated with a transmission channel used by the trace encoder. The trace encoder may be connected to a processor core via a trace interface. The trace encoder may receive instruction trace information (e.g., instruction addresses, instruction types, context information, and the like) from the processor core via the trace interface. The trace encoder may execute in the BTM mode or the HTM mode. In the HTM mode, the trace encoder may store the results of branches (e.g., taken) in a history buffer (e.g., a shift register). When the history buffer fills with branches having a same result (e.g., all branches consecutively taken), the trace encoder may start a count of the branches (e.g., “branch count”) associated with the same result without sending an RFM. In some implementations, the trace encoder may clear the history buffer of the individual branch results, store the branch count in the history buffer, and continue to update (e.g., maintain) the branch count stored in the history buffer when a next branch generates the same result (e.g., increment the count). In some implementations, the trace encoder may store the branch count in a history count buffer. In some implementations, the trace encoder may store the branch count in the history count buffer while tracking results of individual branches in the history buffer. The trace encoder may continue in this way, updating the count when a next branch generates the same result, until a next branch is executed by the processor core with an opposite result (e.g., until a branch is not-taken after multiple branches have been taken).

The process 600 also includes sending 620 a message including the count. The trace encoder may send the message (e.g., an RFM) when, after maintaining a count of branches that generate the same result, a branch is executed by the processor core with an opposite result (e.g., after multiple branches have been taken, a branch is not-taken). When this occurs, the trace encoder may send the message indicating the branch count (e.g., stored as a count in the history buffer and/or the history count buffer). In some implementations, the trace encoder may send the message to a trace buffer. In some implementations, the trace encoder may send the message to a trace funnel that receives messages from one or more other trace encoders, and the trace funnel may send the message to the trace buffer. In some implementations, the trace funnel may interleave the trace messages when sending the system trace messages. The message may include a trace identifier for determining to which processor core the message relates. The message may be sent via a transmission channel like the transmission channel 135 shown in FIG. 1 or the transmission channel 235 shown in FIG. 2. By using the branch count, the number of messages sent by the trace encoder via the transmission channel may be reduced.

The process 600 also includes using 630, by a trace decoder, the count to determine instructions that were executed by the processor core. The count may be used by a trace decoder like the trace decoder 140 shown in FIG. 1 or the trace decoder 240 shown in FIG. 2. The trace decoder may access the messages in a trace buffer. The trace decoder may use the messages to determine the instructions that were executed by the processor core. For example, the trace decoder may execute trace de-queueing software to organize the instructions in an order in which they were executed by the processor core to reconstruct an execution flow. In some implementations, the trace decoder may organize the instructions and reconstruct the execution flow with knowledge of the program that was executed by the processor core (e.g., accessing the source code). The trace decoder may use a trace identifier associated with the message to determine which instructions were executed by the which processor core. In some implementations, the trace decoder may de-interleave the system trace messages, based on the trace identifiers, to establish one stream for each processor core.

The process 600 also includes displaying 640 the instructions to an I/O device. The trace decoder may output the execution flow to the I/O device, which may be like the I/O device 150 shown in FIG. 1 or the I/O device 250 shown in FIG. 2. The I/O device may comprise GUI executing on a computer. The I/O device may permit the execution flow determined by the trace decoder to be viewed by a user, so that the user may scroll back and forth to see instructions that were executed by the processor core. For example, the trace decoder and/or the I/O device may execute post-acquisition display software to display instructions associated with the program that was executed (e.g., the source code) and to display instructions that were actually executed by the processor core, in the order they were executed.

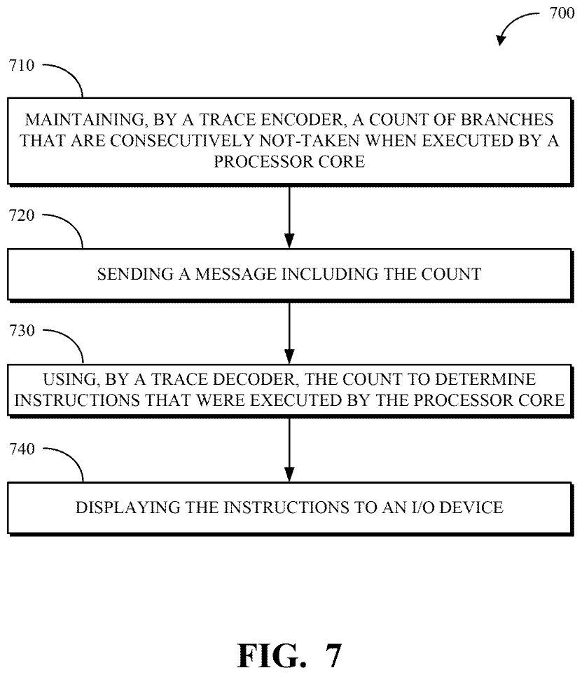

FIG. 7 is a flow chart of an example of a process 700 for instruction tracing using a BHM trace encoder. The process 700 includes maintaining 710, by a trace encoder, a count of branches that are consecutively not-taken when executed by a processor core; sending 720 a message including the count; using 730, by a trace decoder, the count to determine instructions that were executed by the processor core; and displaying 740 the instructions to an I/O device. For example, the process 700 may be implemented using the system 100 shown in FIG. 1, the system 200 shown in FIG. 2, the trace encoder 300 shown in FIG. 3, the trace encoder 400 shown in FIG. 4, and/or the system 500 shown in FIG. 5.

The process 700 includes maintaining 710, by a trace encoder, a count of branches that are consecutively not-taken when executed by a processor core. The count may be maintained by a trace encoder that implements a repeat branch optimization like the trace encoder 300 shown in FIG. 3 or the trace encoder 400 shown in FIG. 4. The count may be maintained to reduce the consumption of bandwidth associated with a transmission channel used by the trace encoder. The trace encoder may be connected to a processor core via a trace interface. The trace encoder may receive instruction trace information (e.g., instruction addresses, instruction types, context information, and the like) from the processor core via the trace interface. The trace encoder may execute in the BTM mode or the HTM mode. In the HTM mode, the trace encoder may store the results of branches (e.g., not-taken) in a history buffer (e.g., a shift register). When the history buffer fills with branches having a same result (e.g., all branches consecutively not-taken), the trace encoder may start a count of the branches (e.g., “branch count”) associated with the same result without sending an RFM. In some implementations, the trace encoder may clear the history buffer of the individual branch results, store the branch count in the history buffer, and continue to update (e.g., maintain) the branch count stored in the history buffer when a next branch generates the same result (e.g., increment the count). In some implementations, the trace encoder may store the branch count in a history count buffer. In some implementations, the trace encoder may store the branch count in the history count buffer while tracking results of individual branches in the history buffer. The trace encoder may continue in this way, updating the count when a next branch generates the same result, until a next branch is executed by the processor core with an opposite result (e.g., until a branch is taken after multiple branches have not been taken).

The process 700 also includes sending 720 a message including the count. The trace encoder may send the message (e.g., an RFM) when, after maintaining a count of branches that generate the same result, a branch is executed by the processor core with an opposite result (e.g., after multiple branches have been not-taken, a branch is taken). When this occurs, the trace encoder may send the message indicating the branch count (e.g., stored as a count in the history buffer and/or the history count buffer). In some implementations, the trace encoder may send the message to a trace buffer. In some implementations, the trace encoder may send the message to a trace funnel that receives messages from one or more other trace encoders, and the trace funnel may send the message to the trace buffer. In some implementations, the trace funnel may interleave the trace messages when sending the system trace messages. The message may include a trace identifier for determining to which processor core the message relates. The message may be sent via a transmission channel like the transmission channel 135 shown in FIG. 1 or the transmission channel 235 shown in FIG. 2. By using the branch count, the number of messages sent by the trace encoder via the transmission channel may be reduced.

The process 700 also includes using 730, by a trace decoder, the count to determine instructions that were executed by the processor core. The count may be used by a trace decoder like the trace decoder 140 shown in FIG. 1 or the trace decoder 240 shown in FIG. 2. The trace decoder may access the messages in a trace buffer. The trace decoder may use the messages to determine the instructions that were executed by the processor core. For example, the trace decoder may execute trace de-queueing software to organize the instructions in an order in which they were executed by the processor core to reconstruct an execution flow. In some implementations, the trace decoder may organize the instructions and reconstruct the execution flow with knowledge of the program that was executed by the processor core (e.g., accessing the source code). The trace decoder may use a trace identifier associated with the message to determine which instructions were executed by the which processor core. In some implementations, the trace decoder may de-interleave the system trace messages, based on the trace identifiers, to establish one stream for each processor core.

The process 700 also includes displaying 740 the instructions to an I/O device. The trace decoder may output the execution flow to the I/O device, which may be like the I/O device 150 shown in FIG. 1 or the I/O device 250 shown in FIG. 2. The I/O device may comprise GUI executing on a computer. The I/O device may permit the execution flow determined by the trace decoder to be viewed by a user, so that the user may scroll back and forth to see instructions that were executed by the processor core. For example, the trace decoder and/or the I/O device may execute post-acquisition display software to display instructions associated with the program that was executed (e.g., the source code) and to display instructions that were actually executed by the processor core, in the order they were executed.

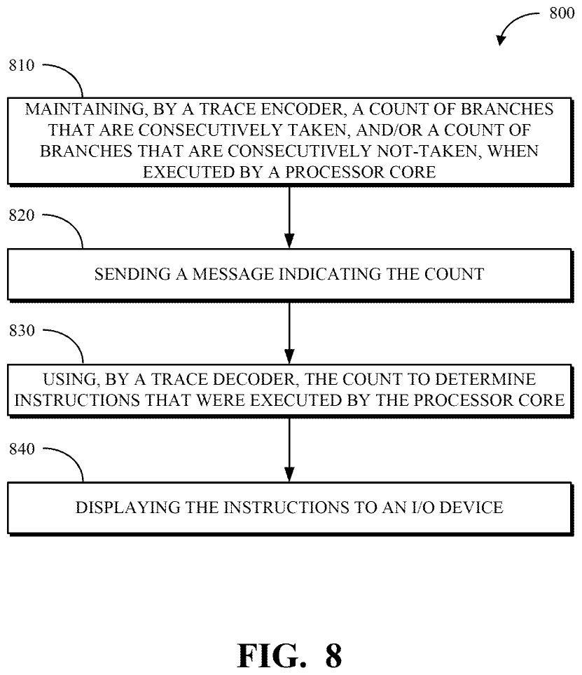

FIG. 8 is a flow chart of an example of a process 800 for instruction tracing using a BHM trace encoder. The process 800 includes maintaining 810, by a trace encoder, a count of branches that are consecutively taken when executed by a processor core, and/or a count of branches that are consecutively not-taken when executed by the processor core; sending 820 a message including the count; using 830, by a trace decoder, the count to determine instructions that were executed by the processor core; and displaying 840 the instructions to an I/O device. For example, the process 800 may be implemented using the system 100 shown in FIG. 1, the system 200 shown in FIG. 2, the trace encoder 300 shown in FIG. 3, the trace encoder 400 shown in FIG. 4, and/or the system 500 shown in FIG. 5.

The process 800 includes maintaining 810, by a trace encoder, a count of branches that are consecutively taken when executed by a processor core, and/or a count of branches that are consecutively not-taken when executed by a processor core. The count may be maintained by a trace encoder that implements a repeat branch optimization like the trace encoder 300 shown in FIG. 3 or the trace encoder 400 shown in FIG. 4. The count may be maintained to reduce the consumption of bandwidth associated with a transmission channel used by the trace encoder. The trace encoder may be connected to a processor core via a trace interface. The trace encoder may receive instruction trace information (e.g., instruction addresses, instruction types, context information, and the like) from the processor core via the trace interface. The trace encoder may execute in the BTM mode or the HTM mode. In the HTM mode, the trace encoder may store the results of branches (e.g., taken or not-taken) in a history buffer (e.g., a shift register). When the history buffer fills with branches having a same result (e.g., all branches consecutively taken, or all branches consecutively not-taken), the trace encoder may start a count of the branches (e.g., “branch count”) associated with the same result without sending an RFM. In some implementations, the trace encoder may clear the history buffer of the individual branch results, store the branch count in the history buffer, and continue to update (e.g., maintain) the branch count stored in the history buffer when a next branch generates the same result (e.g., increment the count). In some implementations, the trace encoder may store the branch count in a history count buffer. In some implementations, the trace encoder may store the branch count in the history count buffer while tracking results of individual branches in the history buffer. The trace encoder may continue in this way, updating the count when a next branch generates the same result, until a next branch is executed by the processor core with an opposite result (e.g., until a branch is not-taken after multiple branches have been taken, or until a branch is taken after multiple branches have not been taken).

The process 800 also includes sending 820 a message including the count. The trace encoder may send the message (e.g., an RFM) when, after maintaining a count of branches that generate the same result, a branch is executed by the processor core with an opposite result (e.g., after multiple branches have been taken, a branch is not-taken, or after multiple branches have not been taken, a branch is taken). When this occurs, the trace encoder may send the message indicating the branch count (e.g., stored as a count in the history buffer and/or the history count buffer). In some implementations, the trace encoder may send the message to a trace buffer. In some implementations, the trace encoder may send the message to a trace funnel that receives messages from one or more other trace encoders, and the trace funnel may send the message to the trace buffer. In some implementations, the trace funnel may interleave the trace messages when sending the system trace messages. The message may include a trace identifier for determining to which processor core the message relates. The message may be sent via a transmission channel like the transmission channel 135 shown in FIG. 1 or the transmission channel 235 shown in FIG. 2. By using the branch count, the number of messages sent by the trace encoder via the transmission channel may be reduced.

The process 800 also includes using 830, by a trace decoder, the count to determine instructions that were executed by the processor core. The count may be used by a trace decoder like the trace decoder 140 shown in FIG. 1 or the trace decoder 240 shown in FIG. 2. The trace decoder may access the messages in a trace buffer. The trace decoder may use the messages to determine the instructions that were executed by the processor core. For example, the trace decoder may execute trace de-queueing software to organize the instructions in an order in which they were executed by the processor core to reconstruct an execution flow. In some implementations, the trace decoder may organize the instructions and reconstruct the execution flow with knowledge of the program that was executed by the processor core (e.g., accessing the source code). The trace decoder may use a trace identifier associated with the message to determine which instructions were executed by the which processor core. In some implementations, the trace decoder may de-interleave the system trace messages, based on the trace identifiers, to establish one stream for each processor core.

The process 800 also includes displaying 840 the instructions to an I/O device. The trace decoder may output the execution flow to the I/O device, which may be like the I/O device 150 shown in FIG. 1 or the I/O device 250 shown in FIG. 2. The I/O device may comprise GUI executing on a computer. The I/O device may permit the execution flow determined by the trace decoder to be viewed by a user, so that the user may scroll back and forth to see instructions that were executed by the processor core. For example, the trace decoder and/or the I/O device may execute post-acquisition display software to display instructions associated with the program that was executed (e.g., the source code) and to display instructions that were actually executed by the processor core, in the order they were executed.

Some implementations may include an apparatus comprising: a processor core; and a trace encoder connected to the processor core, wherein the trace encoder is configured to maintain a count of branches that are consecutively taken when executed by the processor core, and wherein the trace encoder is configured to send a message including the count. In some implementations, the trace encoder is configured to send the message responsive to a branch that is not-taken by the processor core. In some implementations, the count is of direct branches, and a direct branch is associated with a target address that is inferable from a program executed by the processor core. In some implementations, the message is a first message, and the trace encoder is configured to maintain a second count of branches that are consecutively not-taken when executed by the processor core, and the trace encoder is configured to send a second message indicating the second count. In some implementations, the trace encoder comprises a history buffer that stores a number of bits, a branch that is taken by the processor core causes a bit that indicates the branch was taken to be stored in the history buffer, and the trace encoder is configured to start the count when the history buffer fills with bits indicating branches that were consecutively taken. In some implementations, the trace encoder comprises a history buffer that stores a number of bits, a branch that is taken by the processor core causes a bit that indicates the branch was taken to be stored in the history buffer, and the count is greater than the number of bits associated with the history buffer. In some implementations, the trace encoder comprises a history buffer that stores a number of bits, a branch that is taken by the processor core causes a bit that indicates the branch was taken to be stored in the history buffer, and the trace encoder is configured to send the message including the count when a branch that is not-taken is executed by the processor core. In some implementations, the apparatus may further comprise a trace decoder, wherein the trace decoder is configured to use the message to determine instructions that were executed by the processor core. In some implementations, the count of branches is associated with a same branch instruction that executes in a loop.

Some implementations may include a method that includes maintaining, by a trace encoder, a count of branches that are consecutively taken when executed by a processor core connected to the trace encoder; and sending, by the trace encoder, a message including the count. In some implementations, the method may further comprise configuring the trace encoder to send the message responsive to a branch that is not-taken by the processor core. In some implementations, the count is of direct branches, and a direct branch is associated with a target address that is inferable from a program executed by the processor core. In some implementations, the count is a first count, the message is a first message, the trace encoder is configured to maintain a second count of branches that are consecutively not-taken when executed by the processor core, and the trace encoder is configured to send a second message indicating the second count. In some implementations, the method may further comprise configuring a trace decoder to use the message to determine instructions that were executed by the processor core. In some implementations, the count of branches is associated with a same branch instruction that executes in a loop.

Some implementations may include an apparatus that includes: a processor core; and a trace encoder connected to the processor core, wherein the trace encoder is configured to maintain a count of branches that are consecutively not-taken when executed by the processor core, and wherein the trace encoder is configured to send a message including the count. In some implementations, the trace encoder is configured to send the message responsive to a branch that is taken by the processor core. In some implementations, the count is of direct branches, and a direct branch is associated with a target address that is inferable from a program executed by the processor core. In some implementations, the count is a first count, the message is a first message, the trace encoder is configured to maintain a second count of branches that are consecutively not-taken when executed by the processor core, and the trace encoder is configured to send a second message indicating the second count. In some implementations, the apparatus may further comprise a trace decoder, wherein the trace decoder is configured to use the message to determine instructions that were executed by the processor core.

Some implementations may include an apparatus that includes: a processor core; and a trace encoder connected to the processor core, wherein the trace encoder is configured to maintain at least one of a count of branches that are consecutively taken when executed by the processor core or a count of branches that are consecutively not-taken when executed by the processor core, and wherein the trace encoder is configured to send a message including the count. In some implementations, the trace encoder is configured to send the message responsive to a branch that is not-taken when the count is of branches that are consecutively taken or responsive to a branch that is taken when the count is of branches that are consecutively not-taken. In some implementations, the count is of direct branches, and a direct branch is associated with a target address that is inferable from a program executed by the processor core. In some implementations, the apparatus may further comprise a trace decoder, wherein the trace decoder is configured to use the message to determine instructions that were executed by the processor core. In some implementations, the count of branches is associated with a same branch instruction that executes in a loop.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures.

What is claimed is:

1. An apparatus comprising:
a processor core; and
a trace encoder connected to the processor core, wherein the trace encoder is configured to maintain a count of branches that are consecutively taken when executed by the processor core, and wherein the trace encoder is configured to send a message including the count.

2. The apparatus of claim 1, wherein the trace encoder is configured to send the message responsive to a branch that is not-taken by the processor core.

3. The apparatus of claim 1, wherein the count is of direct branches, and wherein a direct branch is associated with a target address that is inferable from a program executed by the processor core.

4. The apparatus of claim 1, wherein the message is a first message, and wherein the trace encoder is configured to maintain a second count of branches that are consecutively not-taken when executed by the processor core, and wherein the trace encoder is configured to send a second message indicating the second count.

5. The apparatus of claim 1, wherein the trace encoder comprises a history buffer that stores a number of bits, wherein a branch that is taken by the processor core causes a bit that indicates the branch was taken to be stored in the history buffer, and wherein the trace encoder is configured to start the count when the history buffer fills with bits indicating branches that were consecutively taken.

6. The apparatus of claim 1, wherein the trace encoder comprises a history buffer that stores a number of bits, wherein a branch that is taken by the processor core causes a bit that indicates the branch was taken to be stored in the history buffer, and wherein the count is greater than the number of bits in the history buffer.

7. The apparatus of claim 1, wherein the trace encoder comprises a history buffer that stores a number of bits, wherein a branch that is taken by the processor core causes a bit that indicates the branch was taken to be stored in the history buffer, and wherein the trace encoder is configured to send the message including the count when a branch that is not-taken is executed by the processor core.

8. The apparatus of claim 1, further comprising:
a trace decoder, wherein the trace decoder is configured to use the message to determine instructions that were executed by the processor core.

9. The apparatus of claim 1, wherein the count of branches is associated with a same branch instruction that executes in a loop.

10. A method comprising:
maintaining, by a trace encoder, a count of branches that are consecutively taken when executed by a processor core connected to the trace encoder; and
sending, by the trace encoder, a message including the count.

11. The method of claim 10, further comprising:
configuring the trace encoder to send the message responsive to a branch that is not-taken by the processor core.

12. The method of any of claim 10, wherein the count is of direct branches, and wherein a direct branch is associated with a target address that is inferable from a program executed by the processor core.

13. The method of any of claim 10, wherein the count is a first count, wherein the message is a first message, wherein the trace encoder is configured to maintain a second count of branches that are consecutively not-taken when executed by the processor core, and wherein the trace encoder is configured to send a second message indicating the second count.

14. The method of any of claim 10, further comprising:
configuring a trace decoder to use the message to determine instructions that were executed by the processor core.

15. The method of any of claim 10, wherein the count of branches is associated with a same branch instruction that executes in a loop.

16. An apparatus comprising:
a processor core; and
a trace encoder connected to the processor core, wherein the trace encoder is configured to maintain a count of branches that are consecutively not-taken when executed by the processor core, and wherein the trace encoder is configured to send a message including the count.

17. The apparatus of claim 16, wherein the trace encoder is configured to send the message responsive to a branch that is taken by the processor core.

18. The apparatus of claim 16, wherein the count is of direct branches, and wherein a direct branch is associated with a target address that is inferable from a program executed by the processor core.

19. The apparatus of claim 16, wherein the count is a first count, wherein the message is a first message, wherein the trace encoder is configured to maintain a second count of branches that are consecutively not-taken when executed by the processor core, and wherein the trace encoder is configured to send a second message indicating the second count.

20. The apparatus of claim 16, further comprising:
a trace decoder, wherein the trace decoder is configured to use the message to determine instructions that were executed by the processor core.
